(19) United States
(12) Patent Application Publication
(10) Pub. No.: US 2021/0226710 A1
(43) Pub. Date: Jul. 22, 2021

(54) AUDIO TRANSMITTER/RECEIVER ARRAY

(71) Applicant: LISNR, Oakland, CA (US)

(72) Inventors: Rebekah Farrar, Columbus, OH (US); Oz Mendel, Piedmont, CA (US); William Knauer, Bellevue, KY (US)

(21) Appl. No.: 16/746,187

(22) Filed: Jan. 17, 2020

(51) Int. Cl. H04B 11/00

(52) U.S. Cl. CPC H04B 11/00

(57) ABSTRACT

The present disclosure provides new and innovative audio transmitter/receiver arrays for receiving and transmitting audio transmissions containing data. The transmitter/receiver arrays may include a plurality of transmitters, such as a speaker, for transmitting audio transmissions and a plurality of receivers, such as a microphone, for receiving audio transmissions. The transmitters and receivers may be mounted on a support body and may be arranged to respectively transmit and receive audio transmission from up to a 360-degree service area surrounding the transmitter/receiver array.

### BACKGROUND

Data often needs to be transmitted between computing devices without connecting both devices to the same computing network. For example, in certain applications, a computing network may not exist near the computing devices, or it may be too cumbersome (e.g., may take too long) to connect one or both of the computing devices to a nearby computing network. Therefore, data may be transmitted directly from one computing device to another computing device.

### SUMMARY

The present disclosure provides new and innovative audio transmitter/receiver arrays for transmitting and receiving data over audio transmissions to and from users in a service area. In a first aspect, an audio transmitter/receiver array is provided comprising a support body and a plurality of receivers mounted on the support body. The plurality of receivers may be arranged to receive audio transmissions from computing devices in a service area. The audio transmitter/receiver array may also include a plurality of transmitters mounted on the support body and the plurality of transmitters may be arranged to transmit audio transmissions to computing devices in the service area.

In a second aspect according to the first aspect, each respective transmitter of the plurality of transmitters corresponds to at least one receiver of the plurality of receivers.

In a third aspect according to any of the first and second aspects, each respective receiver of the plurality of receivers is separated from a respective transmitter of the plurality of transmitters by a respective structural member.

In a fourth aspect according to the third aspect, the respective structural member has a length longer than a height of the respective transmitter.

In a fifth aspect according to any of the first through fourth aspects, the plurality of receivers includes a first quantity of receivers and the plurality of transmitters includes a second quantity of transmitters, and the first quantity is equal to the second quantity.

In a sixth aspect according to the fifth aspect, the first and second quantities are equal to eight.

In a seventh aspect according to any of the first through sixth aspects, the plurality of receivers includes a first quantity of receivers and the plurality of transmitters includes a second quantity of transmitters, and the first quantity is different than the second quantity.

In an eighth aspect according to the seventh aspect, the first quantity is equal to eight and the second quantity is equal to four.

In a ninth aspect according to any of the first through eighth aspects, each respective receiver of the plurality of receivers is integral with a housing of a respective transmitter of the plurality of transmitters.

In a tenth aspect according to any of the first through ninth aspects, the service area includes a 360-degree area surrounding the audio transmitter/receiver array.

In an eleventh aspect according to any of the first through tenth aspects, the service area includes up to a 180-degree area surrounding the audio transmitter/receiver array.

In a twelfth aspect according to any of the first through eleventh aspect, the service area includes up to a 90-degree area surrounding the audio transmitter/receiver array.

In a thirteenth aspect according to any of the first through twelfth aspects, the plurality of receivers are spaced evenly apart from one another on the support body and the plurality of transmitters are spaced evenly apart from one another on the support body.

In a fourteenth aspect according to the thirteenth aspect, the plurality of receivers includes eight receivers and each respective receiver is oriented 45 degrees apart from a next adjacent receiver with respect to a center of the support body.

In a fifteenth aspect according to the thirteenth or fourteenth aspects, the plurality of transmitters includes eight transmitters and each respective transmitter is oriented 45 degrees apart from a next adjacent transmitter with respect to a center of the support body.

In a sixteenth aspect according to any of the first through fifteenth aspects, the audio transmitter/receiver array also includes a housing surrounding the plurality of receivers and the plurality of transmitters.

In a seventeenth aspect according to the sixteenth aspect, the housing includes sound-permeable materials at portions of the housing near the plurality of receivers and portions of the housing near the plurality of transmitters.

In an eighteenth aspect according to the sixteenth or seventeenth aspects, the housing includes gratings or openings at portions of the housing near the plurality of receivers and portions of the housing near the plurality of transmitters.

In a nineteenth aspect according to any of the sixteenth through eighteenth aspects, the housing includes at least one indicator configured to identify, in response to receiving an audio transmission, a direction from which the audio transmission was received.

In a twentieth aspect, an audio transmitter/receiver array is provided that includes a support body and a plurality of receivers mounted on the support body. The plurality of receivers may be arranged to receive audio transmissions from computing devices in a service area. The audio transmitter/receiver array may also include a plurality of transmitters mounted on the support body, and the plurality of transmitters may be arranged to transmit audio transmission to computing devices in the service area. The plurality of receivers may include a first quantity of receivers and the plurality of transmitters may include a second quantity of transmitters. The first quantity may be equal to the second quantity. Each respective transmitter of the plurality of transmitters may also correspond to at least one receiver of the plurality of receivers and each respective receiver of the plurality of receivers may be separated from a corresponding transmitter by a respective structural member.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE DRAWINGS

FIG. 1 shows a system for transmitting and receiving audio transmission, according to an aspect of the present disclosure, according to an aspect of the present disclosure.

FIG. 2 shows a system for transmitting and receiving audio transmission with an audio transmitter/receiver array, according to an aspect of the present disclosure.

FIGS. 3A-3B show a top view and a perspective view, respectively, of a transmitter/receiver array, according to an aspect of the present disclosure.

FIG. 4 shows a perspective view of an example transmitter, according to an aspect of the present disclosure.

FIG. 5 shows a top view of an example transmitter/receiver array, according to an aspect of the present disclosure.

FIG. 6 shows a top view of an example transmitter/receiver array that includes a greater quantity of transmitters than receivers, according to an aspect of the present disclosure.

FIG. 7 shows a perspective view of an example transmitter/receiver configuration, according to an aspect of the present disclosure.

FIG. 8 shows a perspective view of an example transmitter/receiver array with structural members, according to an aspect of the present disclosure.

FIG. 9 shows a perspective view of an example transmitter/receiver array with receivers connected directly to transmitters, according to an aspect of the present disclosure.

FIG. 10 shows a perspective view of an example transmitter/receiver array in which microphones are integrated with transmitter housings, according to an aspect of the present disclosure.

FIG. 11 shows a transmitter/receiver array configured for a 180-degree service area, according to an aspect of the present disclosure.

FIG. 12 shows an example transmitter/receiver array configured for a 90-degree service area, according to an aspect of the present disclosure.

FIG. 13 shows an example system including a housing surrounding a transmitter/receiver array, according to an aspect of the present disclosure.

FIG. 14 shows a service area including two example transmitter/receiver arrays, according to an aspect of the present disclosure.

### DETAILED DESCRIPTION

Aspects of the present disclosure relate to receiving and transmitting audio transmissions containing data between computing devices within a service area. Techniques related to those discussed in the present disclosure are also discussed in U.S. application Ser. No. ______, filed on ______, and titled “MULTI-SIGNAL DETECTION AND COMBINATION OF AUDIO-BASED DATA TRANSMISSIONS,” and U.S. application Ser. No. ______, filed on ______, and titled “DIRECTIONAL DETECTION AND ACKNOWLEDGMENT OF AUDIO-BASED DATA TRANSMISSIONS,” the disclosures of which are herein incorporated by reference.

Various techniques and systems exist to exchange data between computing devices without connecting to the same communication network. For example, the computing devices may transmit data via direct communication links between the devices. In particular, data may be transmitted according to one or more direct wireless communication protocols, such as Bluetooth®, ZigBee®, Z-Wave®, Radio-Frequency Identification (RFID), Near Field Communication (NFC), and Wi-Fi® (e.g., direct Wi-Fi® links between the computing devices). However, each of these protocols relies on data transmission using electromagnetic waves at various frequencies. Therefore, in certain instances (e.g., ZigBee®, Z-Wave®, RFID, and NFC), computing devices may typically require specialized hardware to transmit data according to these wireless communication protocols. In further instances (e.g., Bluetooth®, ZigBee®, Z-Wave®, and Wi-Fi®), computing devices may typically have to be communicatively paired in order to transmit data according to these wireless communication protocols. Such communicative pairing can be cumbersome and slow, reducing the likelihood that users associated with one or both of the computing devices will utilize the protocols to transmit data.

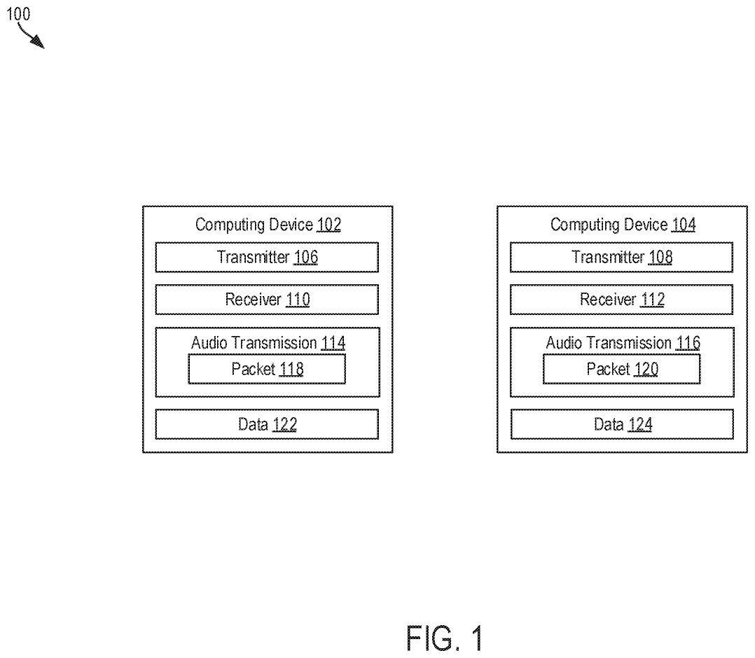

Therefore, there exists a need to wirelessly transmit data in a way that (i) does not require specialized hardware and (ii) does not require communicative pairing prior to data transmission. One solution to this problem is to transmit data using audio transmissions. For example, FIG. 1 illustrates a system 100 according to an aspect of the present disclosure. The system 100 includes two computing devices 102, 104 configured to transmit data 122, 124 using audio transmissions 114, 116. In particular, each computing device 102, 104 includes a transmitter 106, 108 and a receiver 110, 112. The transmitters 106, 108 may include any type of device capable of generating audio signals, such as speakers. In certain implementations, the transmitters 106, 108 may be implemented as a speaker built into the computing device 102, 104. For example, one or both of the computing devices 102, 104 may be a smart phone, tablet computer, and/or laptop with a built-in speaker that performs the functions of the transmitter 106, 108. In other implementations, the transmitters 106, 108 may be implemented as a speaker external to the computing device 102, 104. For example, the transmitters 106, 108 may be implemented as one or more speakers externally connected to the computing device 102, 104.

The receivers 110, 112 may include any type of device capable of receiving audio transmissions and converting the audio transmissions into signals (e.g., digital signals) capable of being processed by a processor of the computing device, such as microphones. In some implementations, the receivers 110, 112 may be implemented as a microphone built into the computing device 102, 104. For example, one or both of the computing devices may be a smartphone, tablet computer, and/or laptop with a built-in microphone that performs the functions of the receivers 110, 112. In other implementations, the receivers 110, 112 may be implemented as a microphone external to the computing device 102, 104. For example, the receivers 110, 112 may be implemented as one or more microphones external to the computing device 102, 104 that are communicatively coupled to the computing device 102, 104. In certain implementations, the transmitter 106, 108 and receiver 110, 112 may be implemented as a single device connected to the computing device. For example, the transmitter 106, 108 and receiver 110, 112 may be implemented as a single device containing at least one speaker and at least one microphone that is communicatively coupled to the computing device 102, 104.

In certain implementations, one or both of the computing devices 102, 104 may include multiple transmitters 106, 108 and/or multiple receivers 110, 112. For example, the computing device 104 may include multiple transmitters 108 and multiple receivers 112 arranged in multiple locations so that the computing device 104 can communicate with the computing device 102 in multiple locations (e.g., when the computing device 102 is located near at least one of the multiple transmitters 108 and multiple receivers 112. In additional or alternative implementations, one or both of the computing devices 102, 104 may include multiple transmitters 106, 108 and/or multiple receivers 110, 112 in a single location. For example, the computing device 104 may include multiple transmitters 108 and multiple receivers 112 located at a single location. The multiple transmitters 108 and multiple receivers 112 may be arranged to improve coverage and/or signal quality in an area near the single location. For example, the multiple transmitters 108 and multiple receivers 112 may be arranged in an array or other configuration so that other computing devices 102 receive audio transmissions 114, 116 of similar quality regardless of their location relative to the transmitters 108 and receivers 112 (e.g., regardless of the location of the computing devices 102 within a service area of the transmitters 108 and receivers 112).

The computing devices 102, 104 may generate audio transmissions 114, 116 to transmit data 122, 124 to one another. For example, the computing devices 102 may generate one or more audio transmissions 114 to transmit data 122 from the computing device 102 to the computing device 104. As another example, the computing device 104 may generate one or more audio transmissions 116 to transmit data 124 from the computing device 104 to the computing device 102. In particular, the computing devices 102, 104 may create one or more packets 118, 120 based on the data 122, 124 (e.g., including a portion of the data 122, 124) for transmission using the audio transmissions 114, 116. To generate the audio transmission 114, 116, the computing devices 102, 104 may modulate the packets 118, 120 onto an audio carrier signal. The computing devices 102, 104 may then transmit the audio transmission 114, 116 via the transmitter 106, 108, which may then be received by the receiver 110, 112 of the other computing devices 102, 104. In certain instances (e.g., where the data 122, 124 exceeds a predetermined threshold for the size of a packet 118, 120), the data 122, 124 may be divided into multiple packets 118, 120 for transmission using separate audio transmissions 114, 116.

Accordingly, by generating and transmitting audio transmissions 114, 116 in this way, the computing devices 102, 104 may be able to transmit data 122, 124 to one another without having to communicatively pair the computing devices 102, 104. Rather, a computing device 102, 104 can listen for audio transmissions 114, 116 received via the receivers 110, 112 from another computing device 102, 104 without having to communicatively pair with the other computing device 102, 104. Additionally, because these techniques can utilize conventional computer hardware like speakers and microphones, the computing devices 102, 104 do not require specialized hardware to transmit the data 122, 124.

However, transmitting data by audio transmissions includes other limitations. In particular, audio transmissions are susceptible to types of interference and/or distortions that are either not present or less prevalent for data transmissions by electromagnetic signals. For instance, different frequencies utilized by the audio transmission may attenuate differently, causing certain frequencies to appear larger in magnitude when received by another computing device. Further, over longer distances, the magnitude of the audio transmission when received may decrease, reducing the signal-to-noise ratio for the received audio transmission. Additionally, accurately transmitting data using audio may require that audio transmissions be transmitted towards a receiving computing device. For example, if an audio transmission is not transmitted towards a computing device, the computing device may receive the audio signal with a lower magnitude, reducing the signal-to-noise ratio for the audio transmission. The computing device may also receive a reflection of the audio transmission instead of the audio transmission itself, which may increase the amount of interference and lower the magnitude of the received audio transmission.

Therefore, there exists a need to receive and transmit audio transmissions in directions facing the computing devices transmitting and/or intended to receive the audio transmissions. One solution to this problem is to provide an array of receivers configured to receive audio signals from multiple directions and transmitters configured to transmit audio signals to multiple directions. For example, the receivers and transmitters may be able to receive and/or transmit audio transmissions from multiple directions within a service area surrounding the array (e.g., a 360-degree service area). In certain implementations, the array may include the same number of transmitters as receivers, more transmitters than receivers, and/or fewer transmitters than receivers.

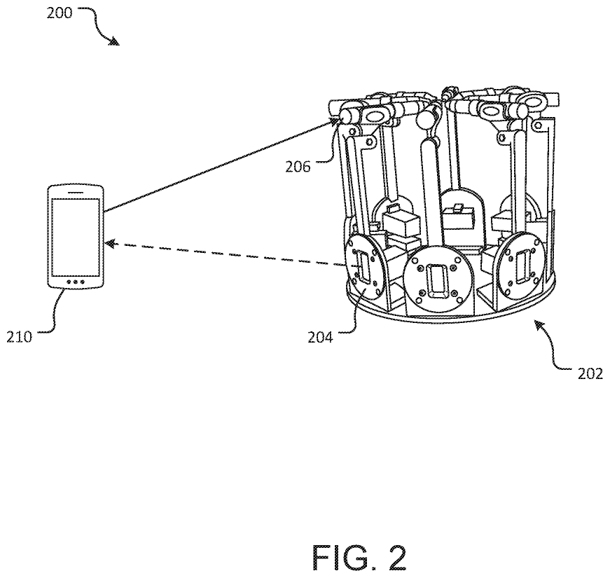

FIG. 2 illustrates a system 200 for transmitting and receiving audio transmissions, according to an aspect of the present disclosure. The system 200 may include an example transmitter/receiver array 202 that may be used to transmit and/or receive audio transmissions from a computing device 210 (e.g., a smartphone). For instance, the transmitter/receiver array 202 and/or the computing device 210 may be an exemplary implementation of at least one of the computing devices 102, 104. In an example, the transmitter/receiver array 202 may transmit an audio transmission from a transmitter 204 (e.g., a speaker) to the computing device 210. The computing device 210 may receive and process the audio transmission, for example, with a built-in microphone. In another example, the transmitter/receiver array 202 may receive an audio transmission from the computing device 210 at a receiver 206 (e.g., a microphone). The computing device 210 may transmit the audio transmission, for example, with a built-in speaker.

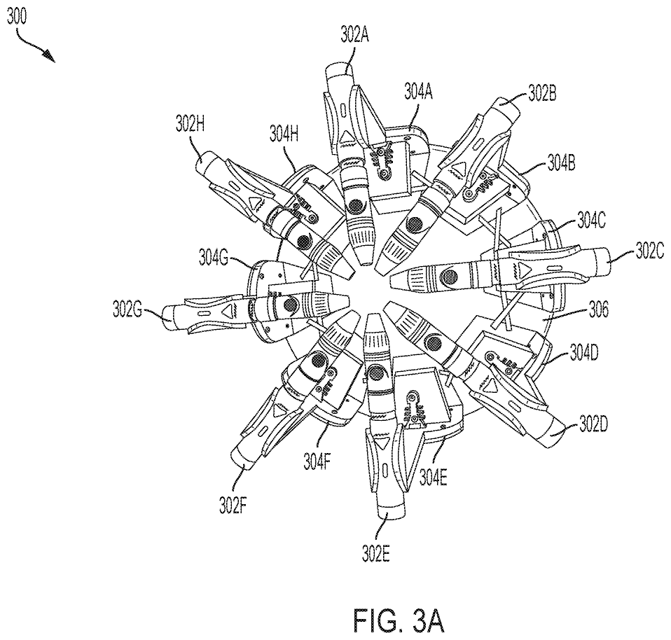

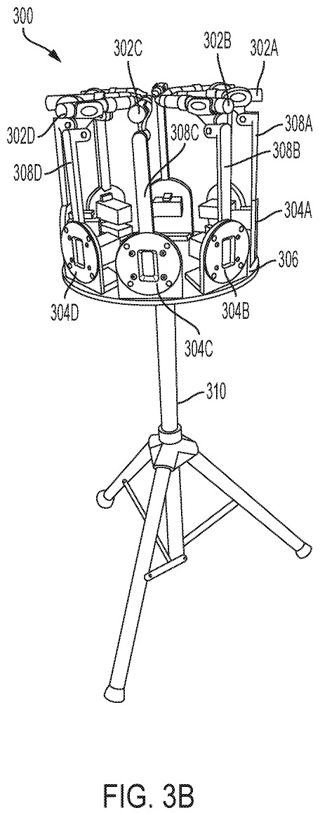

FIGS. 3A-3B illustrate a top view and a perspective view, respectively, of a transmitter/receiver array 300, according to an aspect of the present disclosure. The transmitter/receiver array 300 may be used to transmit and/or receive audio transmissions. For example, the transmitter/receiver array 300 may be an exemplary implementation of at least one of the computing devices 102, 104. The example transmitter/receiver array 300 includes eight receivers 302A-H and eight transmitters 304 A-H. Each of the eight receivers 302A-H may be exemplary implementations of the receivers 110, 112. For example, the eight receivers 302A-H may be implemented as microphones. Each of the eight transmitters 304A-H may be exemplary implementations of the transmitters 106, 108. For example, the eight transmitters 304A-H may be implemented as speakers.

As depicted, the receivers 302A-H and the transmitters 304A-H are arranged to evenly cover a 360-degree area surrounding the transmitter/receiver array 300. For example, the receivers 302A-H and transmitters 304A-H are arranged so that there is approximately 45-degrees between adjacent receivers 302A-H and adjacent transmitters 304A-H. Such a configuration may enable the transmitter/receiver array 300 to receive audio transmissions from and transmit audio transmissions to multiple directions within a coverage or service area of the transmitter/receiver array 300. For example, the transmitter/receiver array 300 may be configured to receive audio transmissions from multiple computing devices in different portions of a service area.

The receivers 302A-H and the transmitters 304A-H may be mounted on a support body 306. The support body 306 may allow the transmitter/receiver array 300 to be positioned and configured without altering the relative orientation of the receivers 302A-H and the transmitters 304A-H. In certain implementations, the receivers 302A-H may be mounted such that the receivers 302A-H are separated from the transmitters 304A-H (e.g., so that the receivers 302A-H can avoid interference from the transmitters 304A-H). For example, the receivers 302A-H may be mounted on structural members 308A-D (only a subset of which are depicted in FIG. 3B) that separate the receivers 302A-H from the transmitters 304A-H. In certain implementations, the transmitter/receiver array 300 may be mounted on a support element, such as the support element 310. The support element 310 may raise the transmitter/receiver array 300 from the ground such that the transmitter/receiver array 300 is at a height better suited to receiving and transmitting audio transmissions (e.g., at or between chest and waist height for a typical individual).

It should be appreciated that additional or alternative implementations of the transmitter/receiver array 300 are possible. Examples of such additional or alternative implementations will be described in detail below.

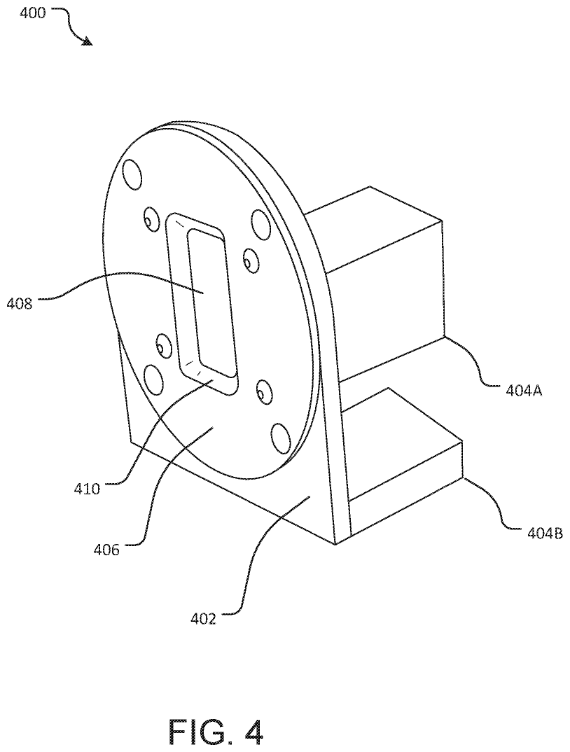

FIG. 4 shows a perspective view of an example transmitter 400, according to an aspect of the present disclosure. The example transmitter 400 may include a speaker 408 capable of transmitting audio transmission. For example, in certain implementations, the speaker 408 may be implemented as a tweeter speaker, such as the Fountek® NeoCD 1.0 Tweeter speaker, although other implementations are possible. The speaker 408 may reside within an example housing 402. For instance, the housing 402 may help protect the speaker 408 from damage by environmental elements and may help prolong the deployment life of the speaker 408. The housing 402 may include a faceplate 406. In some instances, the faceplate 406 may be formed integrally with the housing 402. In other instances, the faceplate 406 may be a separate component that is secured (e.g., with screws or other fasteners) to the housing 402. The faceplate 406 may be adapted to provide a recess 410 that extends outward from the speaker 408. The recess 410, for example, may help direct audio transmission from the speaker 408 in a certain direction, for instance, by reflecting audio transmission in that direction. Additionally, the recess 410 may help protect the speaker 408 from external objects contacting, and possibly damaging, the speaker 408.

The housing 402 may also include the support members 404A, 404B. The support member 404A and/or the support member 404B may be formed integrally with the housing 402 or may be a separate component attached to the housing 402. The support member 404A may include a cavity that houses circuitry and/or other components of the speaker 408 to provide protection from environmental elements and external objects. The support member 404B may be adapted to enable the transmitter 400 to be secured to another component, such as the support body 306. For instance, the support member 404B may be adapted such that it can be secured to the support body with fasteners (e.g., screws). It should be appreciated that, in other examples, the housing 402 may take other suitable forms that help prolong the deployment life of the speaker 408, help direct audio transmission from the speaker 408 in a certain direction, and/or enable the speaker 408 to be oriented according to the present disclosure.

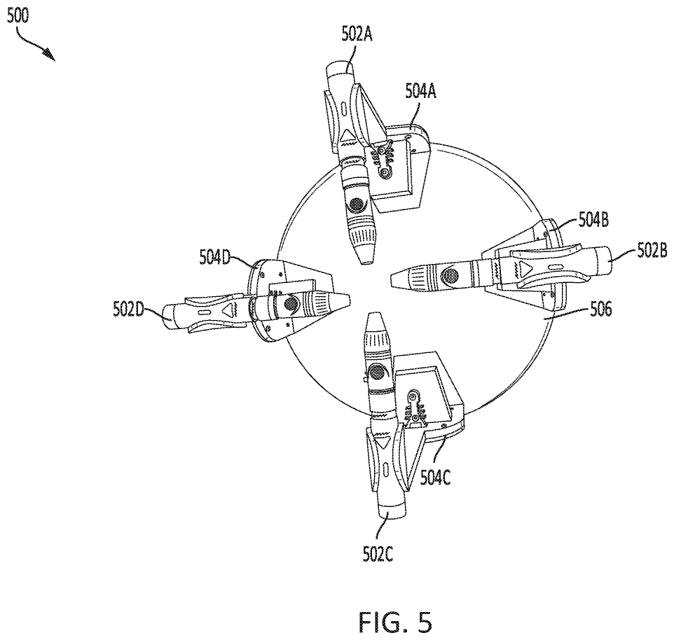

As discussed above with regard to FIGS. 3A and 3B, the example transmitter/receiver array 300 includes eight receivers 302A-H and eight transmitters 304 A-H that are evenly arranged on the support body 306. In other aspects of the present disclosure, the transmitter/receiver array 300 may include more or fewer receivers (e.g., 2, 3, 4, 5, 6, 7, 9, 10, etc.) and/or more or fewer transmitters (e.g., 2, 3, 4, 5, 6, 7, 9, 10, etc.). For example, FIG. 5 shows a transmitter/receiver 500 that includes four receivers 502A-D and four transmitters 504A-D. In some instances, such as the one illustrated, the four receivers 502A-D and four transmitters 504A-D may be arranged evenly on the support body 506 with approximately 90-degrees between adjacent receivers 502A-D and 90-degrees between adjacent transmitters 504A-D. In other instances, the four receivers 502A-D and four transmitters 504A-D may be arranged unevenly on the support body 506.

In examples with other quantities of receivers 502A-D and transmitters 504A-D that may evenly divide 360-degrees (e.g., six receivers with approximately 60-degrees between each), the adjacent receivers 502A-D and the adjacent transmitters 504A-D may be evenly arranged or may be unevenly arranged. In examples with other quantities of receivers 502A-D and transmitters 504A-D that are unable to evenly divide 360-degrees (e.g., seven receivers), the adjacent receivers 502A-D and the adjacent transmitters 504A-D may be approximately evenly arranged or may be unevenly arranged.

In some aspects of the present disclosure, each transmitter of a transmitter/receiver array corresponds to one receiver. For example, each transmitter 504A-D of the transmitter/receiver array 500 corresponds to one receiver 502A-D. More specifically, the transmitter 504A corresponds to the receiver 502A, the transmitter 504B corresponds to the receiver 502B, the transmitter 504C corresponds to the receiver 502C, and the transmitter 504D corresponds to the receiver 502D. This transmitter/receiver array configuration, in some instances, may enable maximum, and evenly distributed, coverage of a service area for both transmitting and receiving audio transmission. In other aspects, the quantity of transmitters of a transmitter/receiver array may be different than the quantity of receivers. For instance, the quantity of transmitters may be greater than the quantity of receivers. In such instances, for example, a transmitter/receiver array may be located in a service area in which it is more important and/or more difficult to transmit audio transmissions than it is to receive them. In another example, the speakers and/or receivers on the transmitter/receiver array may be capable of receiving or transmitting audio transmissions from a wider coverage area than each transmitter is capable of transmitting audio transmission, thus eliminating the need for additional receivers. Additionally or alternatively, the speakers and/or receivers may be capable of receiving or transmitting to different vertical coverages areas (e.g., locations positioned above and/or below the transmitter/receiver array).

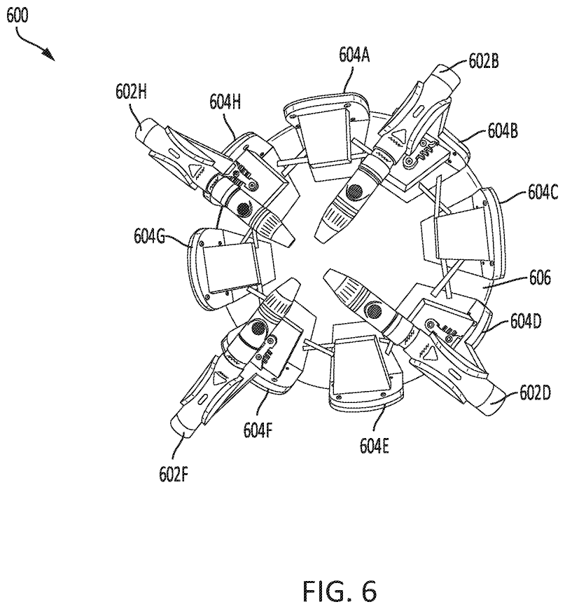

FIG. 6 shows an example transmitter/receiver array 600 that includes eight transmitters 604A-H and four receivers 602B, 602D, 602F, 602H. In such examples, only some of the transmitters 604A-H may directly correspond to a receiver 602B, 602D, 602F, 602H. For instance, the transmitter 604B corresponds to the receiver 602B, the transmitter 604D corresponds to the receiver 602D, the transmitter 604F corresponds to the receiver 602F, and the transmitter 604H corresponds to the receiver 602H. The transmitters 604A, 604C, 604E, and 604G, however, do not correspond to a transmitter.

In other instances, the quantity of receivers may be greater than the quantity of transmitters. In such instances, for example, a transmitter/receiver array may be located in a service area in which it is more important and/or more difficult to receive audio transmissions than it is to transmit them (e.g., because there are many computing devices in the service area transmitting audio transmissions to the transmitter/receiver array). In another example, each transmitter on the transmitter/receiver array may be capable of transmitting audio transmission to a wider coverage area than each receiver is capable of receiving audio transmission, thus eliminating the need for additional transmitters.

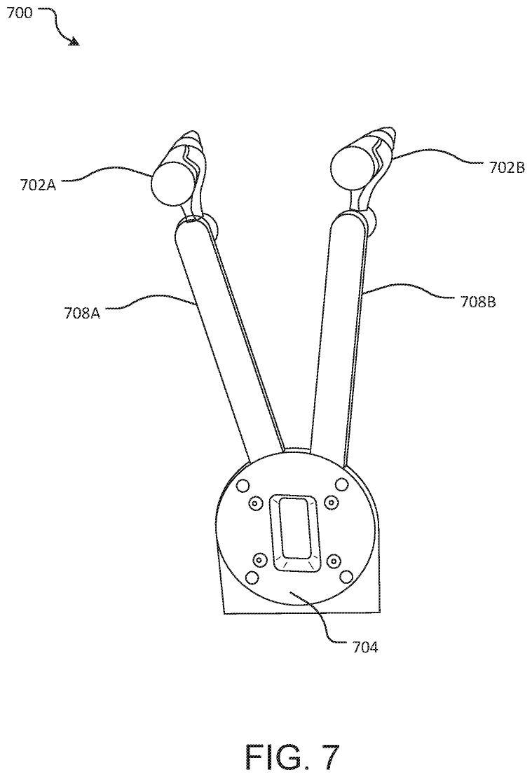

FIG. 7 shows an example transmitter/receiver configuration 700 that includes a transmitter 704 that corresponds to the receiver 702A and the receiver 702B, according to an aspect of the present disclosure. In some instances, a respective structural member 708A and 708B may separate each of the respective receivers 702A and 702B from the transmitter 704. The example transmitter/receiver configuration 700 may be implemented with any of the transmitter/receiver arrays described herein. For example, the transmitter/receiver array 500 may include each transmitter 504A-D corresponding to two receivers. Accordingly, when the transmitter/receiver configuration 700 is implemented with a transmitter/receiver array, the quantity of receivers may be greater than the quantity of transmitters, in some instances.

As has been described, a structural member may separate each receiver in a transmitter/receiver array from a transmitter. For instance, the structural members may help the receivers avoid interference from the transmitters. The length or height of each respective structural member may vary in certain aspects of the present disclosure. In some examples, the length or height of each respective structural member may be greater than the height of the respective transmitter to which the respective structural member corresponds. For instance, each of the structural members 308A-D of the transmitter/receiver array 300 in FIG. 3 have a length or height that is greater than the respective transmitters 304A-D. In such instances, a risk of interference between the receivers and transmitters may be relatively high and the receivers 302A-D are accordingly separated from the transmitters 304A-D to a larger degree than other instances.

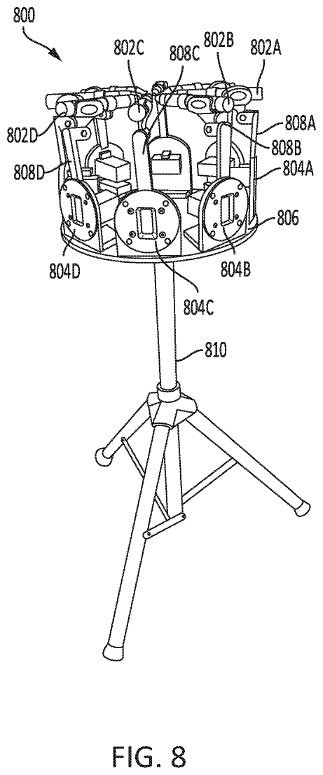

In other examples, the length or height of each respective structural member may be equal to or less than the height of the respective transmitter to which the respective structural member corresponds. FIG. 8 shows an example transmitter/receiver array 800 with structural members 808A-D with a length or height equal to or less than the height of the respective transmitters 804A-D, according to an aspect of the present disclosure. For example, the structural member 808C has a length or height that is less than the length or height of the structural member 308C. In such instances, a risk of interference between the receivers 802A-D and transmitters 804A-D may be less than in the case of the transmitter/receiver array 300, and the receivers 802A-D are accordingly separated from the transmitters 804A-D to a lesser degree. Additionally, the configuration of the example transmitter/receiver array 800 is more compact than the configuration of the example transmitter/receiver array 300 and thus may save space in the service area. The transmitters 804A-D may be secured to a support body 806. In some examples, the transmitter/receiver array 800 may include a support element 810.

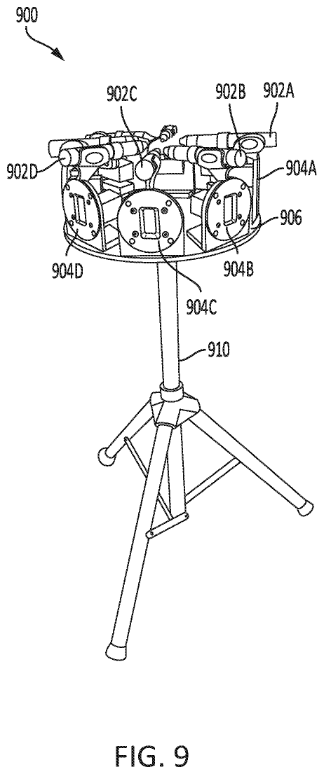

In some aspects of the present disclosure, a transmitter/receiver array may be configured without a structural member. For instance, each receiver of the transmitter/receiver array may be connected directly to the housing of a transmitter. FIG. 9 shows an example transmitter/receiver array 900 with receivers connected directly to transmitters, according to an aspect of the present disclosure. For instance, the receiver 902A is directly connected to the transmitter 904A, the receiver 902B is directly connected to the transmitter 904B, the receiver 902C is directly connected to the transmitter 904C, and the receiver 902D is directly connected to the transmitter 904D. In such instances, a risk of interference between the receivers 902A-D and transmitters 904A-D may be less than in the case of the transmitter/receiver arrays 300 and 800 (e.g., because the transmitters 904A-D may not transmit while the receivers 902A-D receive audio transmissions), and the receivers 902A-D are accordingly separated from the transmitters 904A-D to a lesser degree. Additionally, the configuration of the example transmitter/receiver array 900 is more compact than the preceding examples and thus may save space in the service area. The transmitters 904A-D may be secured to a support body 906. In some examples, the transmitter/receiver array 900 may include a support element 910.

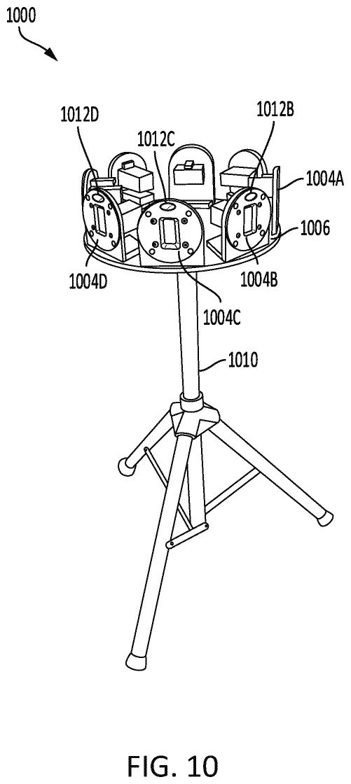

In another aspect, a transmitter/receiver array may be configured such that the transmitters and receivers are integrated as a single component. In such aspects, there may be minimal risk of interference between the transmitters and receivers. For example, FIG. 10 shows a transmitter/receiver array 1000 in which microphones are integrated with transmitter housings, according to an aspect of the present disclosure. More specifically, a microphone 1012B is integrated with the housing of the transmitter 1004B, a microphone 1012C is integrated with the housing of the transmitter 1004C, and a microphone 1012D is integrated with the housing of the transmitter 1004D. The microphones 1012B-D may be built into the housing of each respective transmitter 1004B-D, for example. The configuration of the example transmitter/receiver array 1000 is more compact than the preceding examples and thus may save space in the service area. In some instances, the microphones 1012B-D may extend outward from the faceplate of the housing. In other instances, the faceplate may include a recess for the microphones 1012B-D similar to the recess described above for the speakers. The transmitters 1004A-D may be secured to a support body 1006. In some examples, the transmitter/receiver array 1000 may include a support element 1010. The transmitters and receivers may, additionally or alternatively, be integrated as a single component in other suitable configurations. For example, a speaker of a transmitter may be integrated with a housing of a receiver.

As illustrated in the preceding figures, the transmitters and receivers may be arranged on the support body such that they may respectively transmit and receive audio transmissions within a service area spanning up to 360-degrees around the transmitter/receiver array. The support body may be any suitable shape that enables the transmitters and receivers to be arranged to cover up to the 360-degree service area (e.g., circular, oval, square, decagon, octagon, hexagon, etc.).

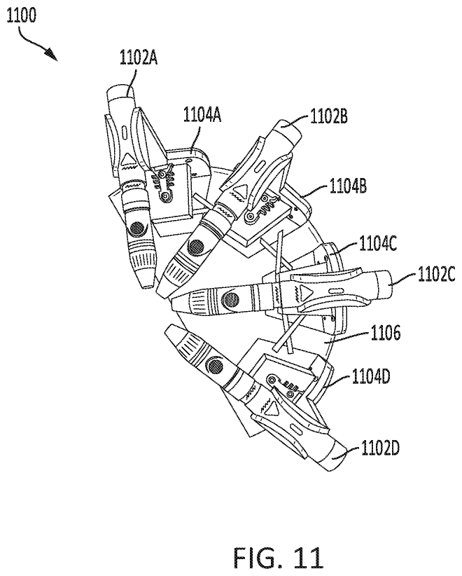

In other aspects of the present disclosure, the transmitters and receivers may be arranged on the support body such that they may respectively transmit and receive audio transmissions within a service area spanning up to 180-degrees surrounding the transmitter/receiver array. In such aspects, the support body may take a correspondingly suitable shape (e.g., half-circle, triangle, trapezoid, square, etc.). FIG. 11 shows an example transmitter/receiver array 1100 configured for a 180-degree service area, according to an aspect of the present disclosure. The support body 1106 is configured in a half-circle shape that includes a straight portion and a curved portion. In at least one example, the transmitter/receiver array 1100 may include four transmitters 1104A-D and four receivers 1102A-D. The transmitters 1104A-D and the receivers 1102A-D may be arranged (e.g., evenly) along the curved portion of the support body 1106. The straight portion of the support body 1106 enables the transmitter/receiver array 1100 to be placed, for example, against a wall of a room. Placing the transmitter/receiver array 1100 against a wall may help keep the transmitter/receiver 1100 out of the way when it is placed in a busy service area (e.g., a supermarket or retail store). Additionally, transmitter/receiver arrays capable of fitting efficiently against a wall may help provide coverage in harder to reach service areas (e.g., service areas away from central portions of a room or store in which audio transmissions may be received).

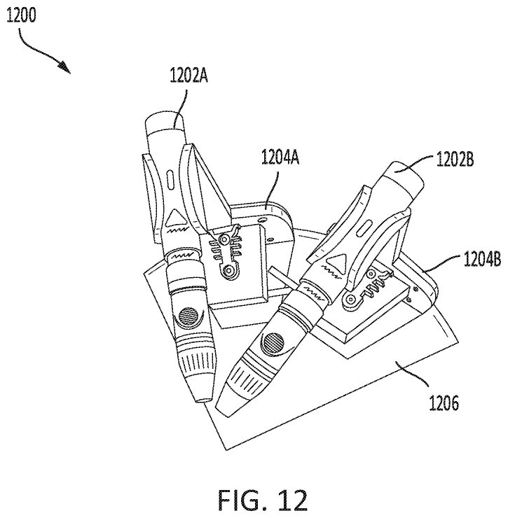

The transmitters and receivers may be arranged, in other aspects, on the support body such that they may respectively transmit and receive audio transmissions from a service area spanning up to 90-degrees surrounding the transmitter/receiver array. In such other aspects, the support body may take a correspondingly suitable shape (e.g., quarter-circle, triangle, etc.). FIG. 12 shows an example transmitter/receiver array 1200 configured for a 90-degree service area, according to an aspect of the present disclosure. The support body 1206 is configured in a quarter-circle shape that includes two straight portions forming a right angle and a curved portion. In at least one example, the transmitter/receiver array 1200 may include two transmitters 1204A-B and two receivers 1202A-B. The transmitters 1204A-B and the receivers 1202A-B may be arranged (e.g., evenly) along the curved portion of the support body 1106. The right-angled portion of the support body 1206 enables the transmitter/receiver array 1200 to be placed, for example, in a corner of a room. Placing the transmitter/receiver array 1100 in a corner may help keep the transmitter/receiver 1100 out of the way when it is placed in a busy service area (e.g., a supermarket or retail store).

In some instances, the support body 1206 may have an angle at its straight portions that is greater than (e.g., 120-degrees) or less than (e.g., 75-degrees) 90-degrees. For example, a corner of a room may be at an angle that is greater than or less than 90-degrees. In such other instances, the transmitters 1204A-B and receivers 1202A-B may respectively transmit and receive audio transmissions from a service area spanning greater than (e.g., 120-degrees) or less than (e.g., 75-degrees) 90-degrees surrounding the transmitter/receiver array.

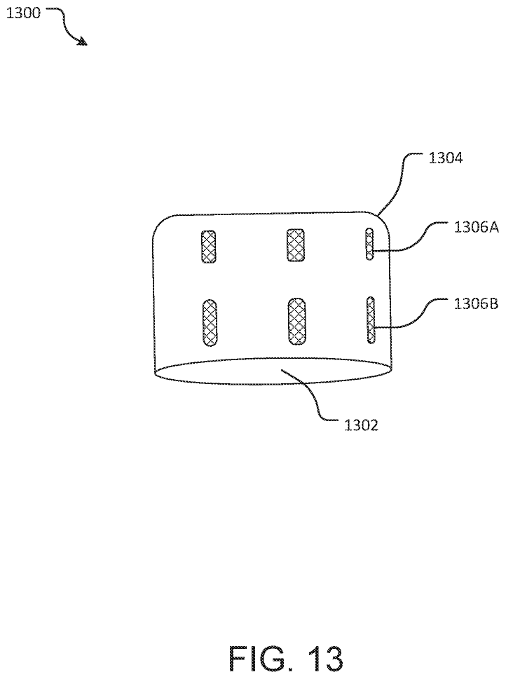

In various aspects of the present disclosure, the transmitter/receiver array may have a housing surrounding the transmitters and receivers. For instance, the housing may connect to the support body and may extend around the transmitters and receivers. FIG. 13 shows an example system 1300 including a housing 1304 surrounding a transmitter/receiver array 1302, according to an aspect of the present disclosure. The housing 1304 may help protect the transmitter/receiver array 1302 from environmental elements. The housing 1304 may be composed of one or more suitable materials, for example, fabric, metal, wood, and/or plastic.

In some examples, the housing 1304 may include openings 1306A at portions of the housing 1304 near respective receivers. The housing 1304 may, additionally or alternatively, include openings 1306B at portions of the housing 1304 near respective transmitters. The openings 1306A and 1306B may increase the capability of the transmitters and receivers to respectively transmit and receive audio transmissions, as compared to transmitting and receiving through the material of the housing 1304. It should be appreciated that only one opening 1306A and one opening 1306B are indicated for simplicity, though the housing 1304 may include a respective opening 1306A, 1306B for each respective receiver and transmitter. In some instances, an opening 1306A and/or an opening 1306B may be a complete absence of material. In other instances, such as the one illustrated, the opening 1306A and/or the opening 1306B may be configured as a grating such that there is a partial absence of material with overlapping material strands.

Other examples of the housing 1304 may completely surround the transmitter/receiver array 1302. Stated differently, the housing 1304 may not include openings 1306A and 1306B in such others examples. For example, in such other examples, the housing 1304 may include sound-permeable material at portions of the housing 1304 near respective transmitters and receivers, such as fabric or plastic. The sound-permeable material may interfere with audio transmissions to a degree that is insignificant for the receivers to suitably receive and process the audio transmissions. The sound-permeable material may also interfere with audio transmissions to a degree that is insignificant for the transmitters to suitably transmit audio transmissions such that external computing devices may suitably receive and process the audio transmissions. In certain implementation, the openings 1306A-B may include sound-permeable material.

In some aspects of the present disclosure, the housing 1304 may include at least one indicator configured to identify, in response to receiving an audio transmission, a direction from which the audio transmission was received. For example, the housing 1304 may include an indicator (e.g., 8) for each respective receiver (e.g., 8). The housing 1304 may include a single respective indicator at a portion of the housing 1304 near each respective receiver. When a respective receiver receives an audio transmission, the receiver may, in some instances, transmit a signal to its respective indicator. In other instances, the receiver may transmit a signal to a control unit of the transmitter/receiver array, and the control unit may transmit a signal to the indicator that corresponds to the receiver that transmitted the signal. In response to receiving the signal, the indicator may activate. For example, the indicator may be a light that turns on when it is activated. The light may be any suitable color (e.g., red, blue, green, etc.). Accordingly, the housing 1304 may indicate a direction from which an audio transmission was received.

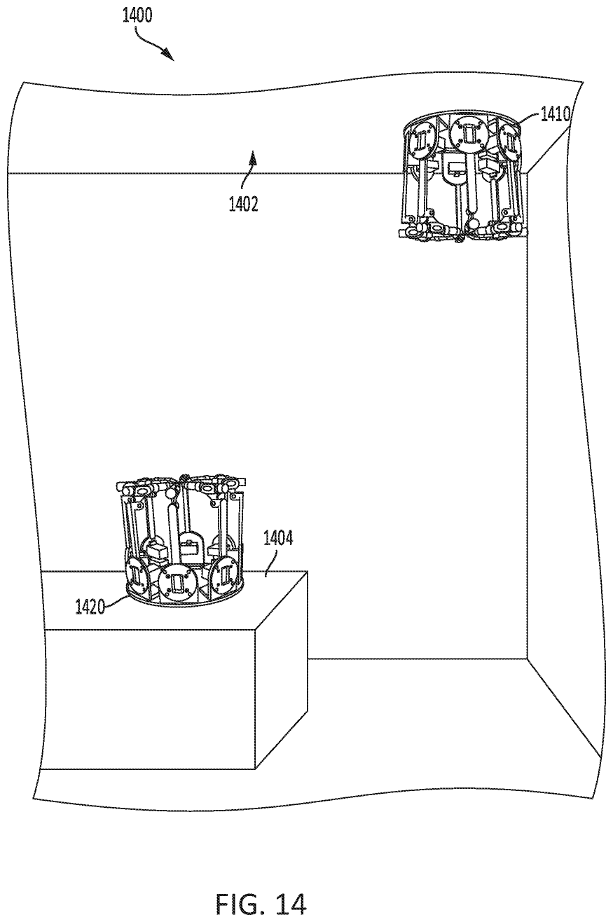

FIG. 14 shows a service area 1400 including two example transmitter/receiver arrays, according to an aspect of the present disclosure. In some instances, a transmitter/receiver array 1420 may be placed atop a counter or table 1404. In other instances, a transmitter/receiver 1410 may be configured such that its support body may be secured to the ceiling 1402. Securing the transmitter/receiver array 1410 to the ceiling 1402 may help keep the transmitter/receiver 1410 out of the way when it is placed in a busy service area (e.g., a supermarket or retail store).

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number.

Without further elaboration, it is believed that one skilled in the art can use the preceding description to utilize the claimed inventions to their fullest extent. The examples and embodiments disclosed herein are to be construed as merely illustrative and not a limitation of the scope of the present disclosure in any way. It will be apparent to those having skill in the art that changes may be made to the details of the above-described embodiments without departing from the underlying principles discussed. In other words, various modifications and improvements of the embodiments specifically disclosed in the description above are within the scope of the appended claims. For example, any suitable combination of features of the various embodiments described is contemplated.

1. An audio transmitter/receiver array comprising:
a support body;
a plurality of receivers mounted on the support body, the plurality of receivers arranged to receive audio transmissions from computing devices in a service area; and
a plurality of transmitters mounted on the support body, the plurality of transmitters arranged to transmit audio transmissions to computing devices in the service area.

2. The audio transmitter/receiver array of claim 1, wherein each respective transmitter of the plurality of transmitters corresponds to at least one receiver of the plurality of receivers.

3. The audio transmitter/receiver array of claim 1, wherein each respective receiver of the plurality of receivers is separated from a respective transmitter of the plurality of transmitters by a respective structural member.

4. The audio transmitter/receiver array of claim 3, wherein the respective structural member has a length longer than a height of the respective transmitter.

5. The audio transmitter/receiver array of claim 1, wherein the plurality of receivers includes a first quantity of receivers and the plurality of transmitters includes a second quantity of transmitters, and the first quantity is equal to the second quantity.

6. The audio transmitter/receiver array of claim 5, wherein the first and second quantities are equal to eight.

7. The audio transmitter/receiver array of claim 1, wherein the plurality of receivers includes a first quantity of receivers and the plurality of transmitters includes a second quantity of transmitters, and the first quantity is different than the second quantity.

8. The audio transmitter/receiver array of claim 7, wherein the first quantity is equal to eight and the second quantity is equal to four.

9. The audio transmitter/receiver array of claim 1, wherein each respective receiver of the plurality of receivers is integral with a housing of a respective transmitter of the plurality of transmitters.

10. The audio transmitter/receiver array of claim 1, wherein the service area includes a 360-degree area surrounding the audio transmitter/receiver array.

11. The audio transmitter/receiver array of claim 1, wherein the service area includes up to a 180-degree area surrounding the audio transmitter/receiver array.

12. The audio transmitter/receiver array of claim 1, wherein the service area includes up to a 90-degree area surrounding the audio transmitter/receiver array.

13. The audio transmitter/receiver array of claim 1, wherein the plurality of receivers are spaced evenly apart from one another on the support body and the plurality of transmitters are spaced evenly apart from one another on the support body.

14. The audio transmitter/receiver array of claim 13, wherein the plurality of receivers includes eight receivers and each respective receiver is oriented 45 degrees apart from a next adjacent receiver with respect to a center of the support body.

15. The audio transmitter/receiver array of claim 13, wherein the plurality of transmitters includes eight transmitters and each respective transmitter is oriented 45 degrees apart from a next adjacent transmitter with respect to a center of the support body.

16. The audio transmitter/receiver array of claim 1, further comprising a housing surrounding the plurality of receivers and the plurality of transmitters.

17. The audio transmitter/receiver array of claim 16, wherein the housing includes sound-permeable materials at portions of the housing near the plurality of receivers and portions of the housing near the plurality of transmitters.

18. The audio transmitter/receiver array of claim 16, wherein the housing includes gratings or openings at portions of the housing near the plurality of receivers and portions of the housing near the plurality of transmitters.

19. The audio transmitter/receiver array of claim 16, wherein the housing includes at least one indicator configured to identify, in response to receiving an audio transmission, a direction from which the audio transmission was received.

20. An audio transmitter/receiver array comprising:
a support body;
a plurality of receivers mounted on the support body, the plurality of receivers arranged to receive audio transmissions from computing devices in a service area; and
a plurality of transmitters mounted on the support body, the plurality of transmitters arranged to transmit audio transmission to computing devices in the service area,
wherein the plurality of receivers includes a first quantity of receivers and the plurality of transmitters includes a second quantity of transmitters, and the first quantity is equal to the second quantity, and
wherein each respective transmitter of the plurality of transmitters corresponds to at least one receiver of the plurality of receivers and each respective receiver of the plurality of receivers is separated from a corresponding transmitter by a respective structural member.
